(19) United States
(12) Patent Application Publication
(10) Pub. No.: US 2007/0285036 A1
(43) Pub. Date: Dec. 13, 2007

(54) A DEVICE AND METHOD FOR REDUCING DISK DRIVE POWER CONSUMPTION

(75) Inventors: Scott L. McCurdy, Whitehall, PA (US); Steven E. Strauss, Orefield, PA (US)

Correspondence Address: HITT GAINES, PC;LSI Corporation, PO BOX 832570, RICHARDSON, TX, 75083, US

(73) Assignee: Agere Systems, Inc., Allentown, PA (US)

(21) Appl. No.: 11/422,941

(22) Filed: Jun. 8, 2006

(51) Int. Cl. H02P 7/00; H02P 1/00

(52) U.S. Cl. 318/272

(57) ABSTRACT

Introduced is a device to reduce disk drive power consumption during start-up. In one embodiment the device provides for (1) a speed control module associated with a disk drive motor; and (2) a controller coupled to the speed control module that incrementally increases the spindle rotational speed of the disk drive motor during start-up.

### TECHNICAL FIELD OF THE INVENTION

The present invention is directed, in general, to a power control device and more particularly, to a device and method for reducing the power consumption of a disk drive during start-up.

### BACKGROUND OF THE INVENTION

Most computers, including portable computers, include one or more disk drives as a standard feature. As more and more functions, including traditional computer functions, are integrated into other devices such as mobile telephones, PDAs and digital cameras, these devices are, or will be, increasingly equipped with disk drives. Thus, we now find ourselves with very small computer devices that are being operated at very high speeds. To minimize disk drive data access time, it is important that the drives operate at very high speeds. In fact, the faster these drives rotate, the better the data transfer performance, which means that data can be read off the disk at a faster rate during sequential operations. Increased speed also reduces rotational latency, which is the time the heads reading data from the disk must wait for the correct sector number, thereby improving random operations. For these reasons, the push to increase the spindle speed of disk drive motors continues.

There are several design challenges in increasing disk drive spindle speeds. Some of these challenges include controlling vibration and heat caused by increased drive power consumption. These problems or challenges are usually addressed by designing engineering features into the disk drive. For example, some disk drives with higher spindle speeds require special mounting and cooling features so that they can run without heat, vibration and noise problems. To a certain extent, a trade off is made between spindle speed and power, heat and noise issues. Further, it can be more difficult to overcome such problems when the disk drive is in a smaller device, such as a mobile phone, PDA, or camera.

In many disk drives, particularly those of a recent vintage, much of the power usage is taken up by the disk drive motor. Smaller disk drives typically require relatively little power to keep the disk platters spinning continuously compared to the larger drives. Indeed, due to improved engineering, even the larger drives with fast spindle speeds take considerably less power than did comparably sized drives of a few years ago.

As one skilled in the art will appreciate, when a disk drive is first started, the disk drive motor can draw two to four times the power that typically is required to keep the drive spinning. This is because more energy is required to overcome inertia. Further, with some systems, the large amount of torque required to start a disk drive introduces other problems in addition to the amount of current drain. For example, over torquing can lead to premature gear train failure of the disk drive. Driving the disk drive motor hard will also introduce electrical noise that can interfere with several other aspects of the device.

Accordingly, what is needed is a device to reduce disk drive power consumption on start-up.

### SUMMARY OF THE INVENTION

To address the above-discussed deficiencies of the prior art, one embodiment of the present invention provides a device to reduce disk drive power consumption during start-up. In one embodiment, the device provides for (1) a speed control module associated with a disk drive motor; and (2) a controller coupled to the speed control module that incrementally increases the spindle rotational speed of the disk drive during start-up.

Thus, embodiments of the present invention provide a device to bring a disk drive up to operating speed while reducing in-rush start-up current. These embodiments can be particularly advantageous when incorporated in a battery powered device with a disk drive, because the disk drive can be incrementally brought up to speed, thereby reducing the load on the battery or batteries, and thus, extending the device's operating life between battery charges or replacement. It gives users of battery powered devices additional operational functionality.

In one embodiment, the controller incrementally increases the spindle rotational speed of the disk drive motor during start-up in a series of predetermined steps. These predetermined steps can be pre-programmed into software that control the rate at which the rotational spindle speed of the disk drive motor is to be increased.

A particularly beneficial embodiment of the invention provides for it to be incorporated within a portable battery powered device. As noted above, this permits the controller to incrementally increase spindle rotational speed of the disk drive motor during start-up and avoid in-rush current with a resultant extension of useable battery life. In some embodiments, the portable battery powered device can be, for example, a mobile telephone, a PDA, an MDA, a pocket PC, a tablet PC, a camera, a digital audio player, such as an MP3 player, or any combination of these devices.

In another embodiment, the controller includes software that drives a digital to analog converter with increasing values. The software can provide for values that are increased in a linear manner or, in another embodiment, in a non-linear manner.

Another embodiment of the invention provides for a method of using a device to reduce disk drive power consumption during start-up. One such embodiment provides for (1) associating a speed control module with a disk drive motor; and (2) causing a controller coupled to the speed control module to incrementally increase the spindle rotational speed of the disk drive during start-up.

Yet another embodiment of the invention provides a method of manufacturing a device to reduce disk drive power consumption. The method, in one embodiment, provides for (1) forming a speed control module and associating it with a disk drive motor; and (2) coupling a controller to the speed control module for incrementally increasing the spindle rotational speed of the disk drive motor during start-up.

The foregoing has outlined various features and embodiments of the present invention so that those skilled in the pertinent art may better understand the detailed description of the invention that follows. Additional features and embodiments of the invention will be described hereinafter that form the subject of the claims of the invention. Those skilled in the pertinent art should appreciate that they can readily use the disclosed conception and specific embodiments as a basis for designing or modifying other structures for carrying out the same purposes of the present invention. Those skilled in the pertinent art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIGS. 1A and 1B illustrate an isometric view of a portable battery powered device with a disk drive that includes an embodiment of the present invention for reducing disk drive power consumption during start-up;

FIG. 2 illustrates a block diagram of an embodiment of the present invention for reducing disk drive power consumption during the start-up of a portable battery powered device of the type illustrated in FIG. 1B;

FIG. 3 illustrates the power profile of a prior art disk drive during start-up;

FIG. 4 illustrates a representative example of a power profile of a disk drive during start-up where the disk drive includes an embodiment of the present invention incorporated therein; and

FIG. 5 illustrates a block diagram of one embodiment of a method of manufacturing a device for reducing disk drive power consumption on start-up where the device is constructed in accordance with the present invention.

### DETAILED DESCRIPTION

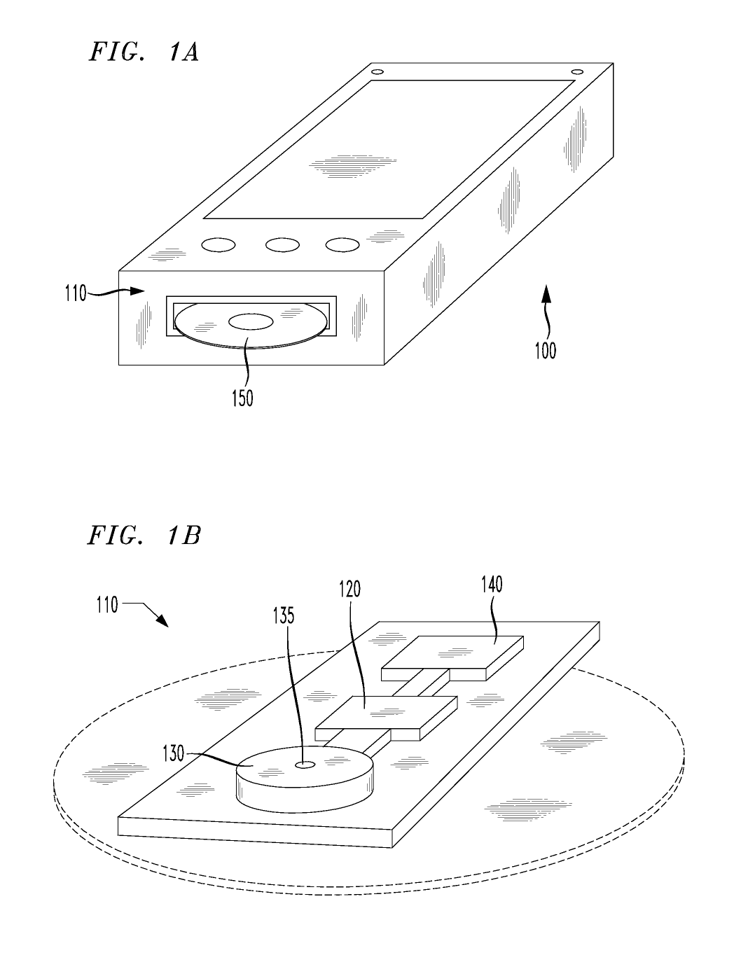

Referring initially to FIGS. 1A and 1B, illustrated is an isometric view of a portable battery powered device 100 with a disk drive 110. Associated with the disk drive 110 is an embodiment of the present invention for reducing disk drive 110 power consumption during start-up. The illustrated embodiment has a speed control module 120 associated with a disk drive motor 130. Extending from the disk drive motor 130 is a spindle 135 for holding a disk 150 or platter. Coupled to the speed control module 120 is a controller 140 for incrementally controlling the speed at which the spindle 135 rotates when the disk drive motor 130 is started.

The illustrated battery powered device 100 is intended to be representative of a personal digital assistant (PDA) 100. As will be readily understood by those skilled in the relevant art, the present invention can be employed in any one of a number of different types or kinds of portable battery powered devices 100 and still be within the intended scope of the present invention. For example, the portable battery powered device 100 could be a mobile telephone, a mobile digital assistant (MDA), a pocket PC, a tablet PC, a camera, a digital audio player, such as an MP3 player, or the like and still be within the scope of the present invention if an embodiment of the inventive feature described herein is included.

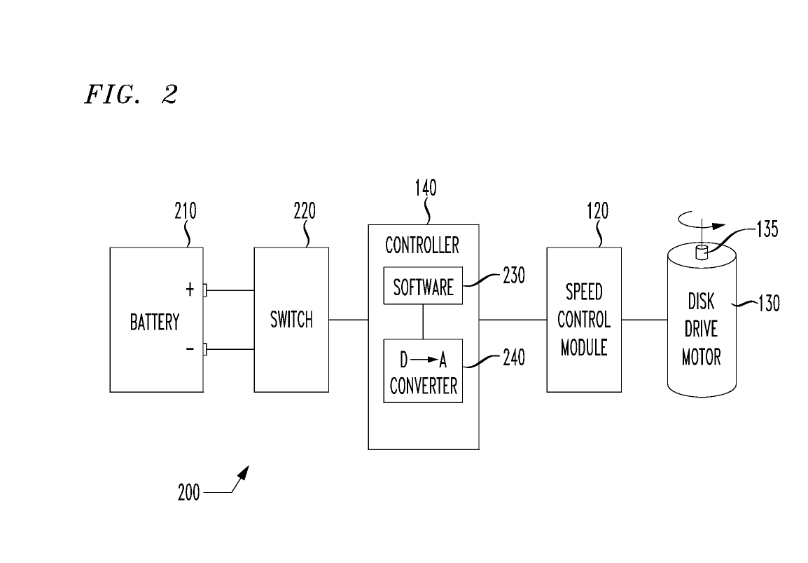

Referring now to FIG. 2, illustrated is a block diagram 200 of an embodiment of the present invention for reducing disk drive 110 power consumption during the start-up of a portable battery powered device 110 of the type illustrated in FIG. 1B. In the illustrated embodiment, power is provided to the disk drive system by a battery 210 or, in some devices, a plurality of batteries 210. If the battery powered portable device 100 is a prior art device, current from the battery 210 would go directly to the disk drive motor 130 when a power switch 220 is turned on. Typically, prior art devices would immediately provide full power to the disk drive motor 130, and then it would spin up to its operating speed. The spindle 135 rotational speed could range from 4,200 rpm in the case of a laptop computer to as high as 15,000 rpm for a top of the line SCSI device, or even higher for certain recently developed devices. The spin-up to operational speed would, in the case of prior art devices, typically results in a large current spike or “in-rush” current. In the case of battery-powered devices, the current spike increases the battery discharge rate, which can reduce the total charge available for operating the device 100. In addition, other adverse affects from “in-rush” current can include noise transmission to other components and perhaps a reduction of disk drive motor 130 reliability.

To reduce the effects of in-rush current on start-up, embodiments of the present invention reduce disk drive 110 power consumption by controlling the spindle 135 rotational speed, so that all the battery 210 current is not fed to the disk drive motor 130 at once during start-up. The speed control module 120, associated with the disk drive motor 130, controls the amount of current pushed through on start-up. Coupled to the speed control module 120 is the controller 140, to incrementally increase spindle 135 rotational speed.

In one embodiment of the invention, the controller 140 includes software 230 for driving a digital to analog converter 240 with increasing voltage values. In an associated embodiment, the values are increased in a linear manner while in another the values are increased in a non-linear manner. When increased in a non-linear manner, the spindle 135 rotational speed can be increased in a series of predetermined steps. For example, if the operational spindle 135 speed is 10,000 rpm, the rotational speed can be increased in sequential steps from 4,800 rpm, to 5,400 rpm, to 7,200 rpm, and, finally to the operational speed of 10,000 rpm.

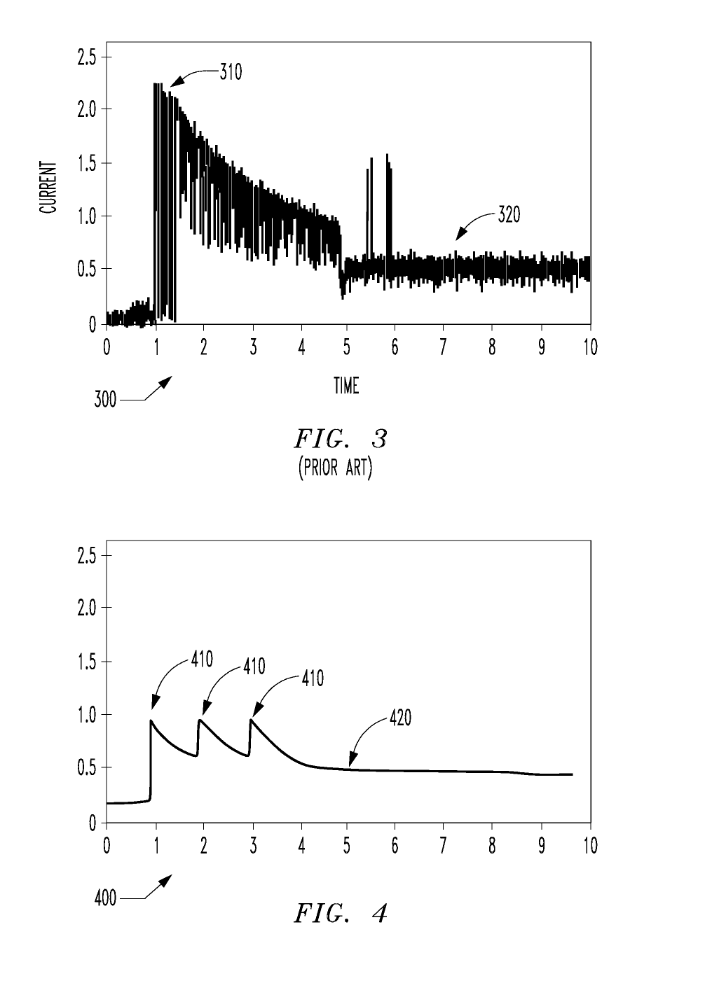

Turning to FIG. 3, illustrated is a prior art power profile 300 of a disk drive 110 during start-up. This prior art power profile 300 shows that, during start-up, the prior art device maximizes current flow (see 310) at about four times that required for steady state operations (see 320). Note that the prior art power profile 300 appears “noisy” because of frequent oscillations in the current requirements.

Turning now to FIG. 4, illustrated is a representative example of a power profile 400 of a disk drive 110 during start-up where the disk drive 110 includes an embodiment of the present invention. This power profile 400 shows spindle 135 rotational speed being increased in a series of predetermined steps 410 and illustrates that the power profile 400 maximizes during start-up at about twice that required for steady state operations 420. This results in a substantial reduction of the current required during start-up and, in the case of a battery powered device, provides a noticeable increase in battery life.

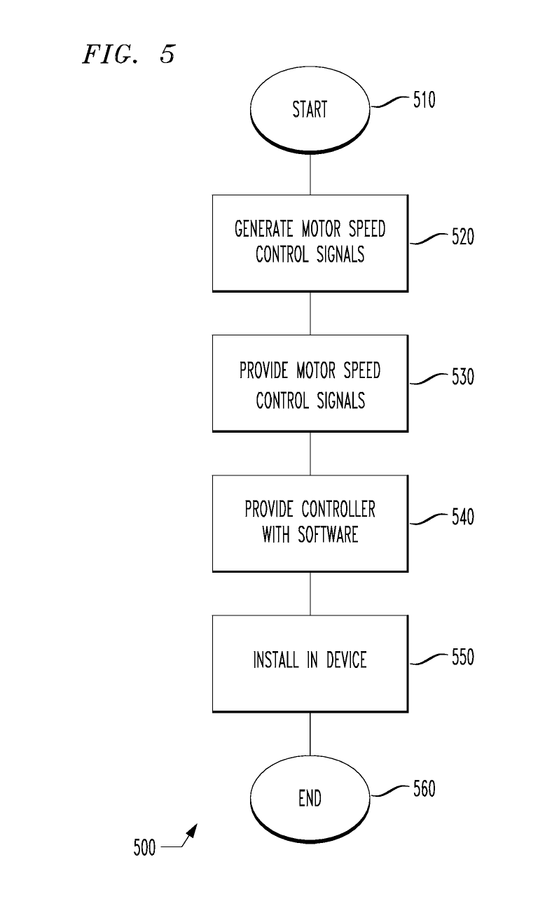

Turning now to FIG. 5, illustrated is a block diagram of one embodiment of a method of operating 500 a device for reducing disk drive power consumption on start-up. The method commences with a start step 510. In a generate motor speed control signals step 520, a speed control module generates signals to be used to control the disk drive spindle speed. In a provide motor speed control signals step 530, the motor speed control signals are provided to a disk drive motor by a controller coupled to the disk drive motor. The motor speed control signals are operable to cause the disk drive motor to incrementally increase its spindle rotational speed during start-up. In one embodiment of the present invention, the motor speed control signals are operable to incrementally increase the spindle rotational speed during start-up in a series of predetermined steps.

In one embodiment of the invention, the method calls for a provide controller with software step 540. In this step, the controller is provided with software driving a digital to analog converter with increasing voltage values. This software can provide for increasing values in a linear manner or in a non-linear manner or a combination thereof.

A useful embodiment calls for an install in device step 550 wherein the invention is incorporated within a portable battery powered device. This portable battery powered device can be selected from the group consisting of a mobile telephone, a PDA, an MDA, a pocket PC, a tablet PC, a camera, or a digital audio player and be within the scope of the intended invention. The method concludes with an end step 560

The present invention also includes several additional embodiments, which embodiments are readily apparent to those skilled in the pertinent art from the forgoing description. Although the present invention has been described in detail, those skilled in the pertinent art should understand that they can make various changes, substitutions and alterations herein without departing from the spirit and scope of the invention in its broadest form.

1. A device for increasing battery life by reducing disk drive power consumption, comprising:
a speed control module associated with a disk drive motor for a battery powered device; and
a controller coupled to said speed control module, said controller regulating battery current provided to said disk drive motor during start-up to increase its said disk drive motor's spindle speed in a series of predetermined increments.

2. (canceled)

3. The device as recited in claim 1 wherein said disk drive is incorporated within a portable battery powered device.

4. The device as recited in claim 3 wherein said portable battery powered device is selected from the group consisting of:
a mobile telephone;
a PDA;
an MDA;
a pocket PC;
a tablet PC;
a camera; or
a digital audio player.

5. The device as recited in claim 1 wherein said controller includes software driving a digital to analog converter with increasing values.

6. The device as recited in claim 5 wherein said values are increased in a linear manner.

7. The device as recited in claim 5 wherein said values are increased in a non-linear manner.

8. The device as recited in claim 5 wherein said values are voltage values.

9. A method of increasing battery life by reducing disk drive power consumption, comprising:
providing a speed control module to be associated with a disk drive motor in a battery powered device; and
providing a controller to be coupled to said speed control module for regulating the amount of battery current provided to said disk drive motor during start-up to increase said disk drive motor's spindle speed in a series of predetermined increments.

10. (canceled)

11. The method as recited in claim 9 wherein said disk drive is incorporated within a portable battery powered device.

12. The method as recited in claim 11 wherein said portable battery powered device is selected from the group consisting of:
a mobile telephone;
a PDA;
an MDA;
a pocket PC;
a tablet PC;
a camera; or
a digital audio player.

13. The method as recited in claim 9 wherein said controller includes software driving a digital to analog converter with increasing voltage values.

14. The method as recited in claim 13 wherein said voltage values are increased in a linear manner.

15. The method as recited in claim 13 wherein said values are increased in a non-linear manner.

16. A portable battery powered electronic device, comprising:
a disk drive having a speed control module associated with a said disk drive's motor; and
a controller coupled to said speed control module for regulating battery current provided to said disk drive motor during start-up and increasing to said disk drive motor's spindle speed in a series of predetermined increments.

17. (canceled)

18. The portable device as recited in claim 16 wherein said portable battery powered electronic device is selected from the group consisting of:
a mobile telephone;
a PDA;
an MDA;
a pocket PC;
a tablet PC;
a camera; or
a digital audio player.

19. The portable device as recited in claim 16 wherein the controller includes software driving a digital to analog converter with increasing voltage values.

20. The portable device as recited in claim 16 wherein said values are increased in a linear manner.

21. The portable device as recited in claim 16 wherein said values are increased in a non-linear manner.
